(19) United States
(12) Patent Application Publication
(10) Pub. No.: US 2006/0207634 A1
(43) Pub. Date: Sep. 21, 2006

(54) Methods and apparatus for maintaining a fluid level in a tank

(75) Inventor: Younes Achkire, Los Gatos, CA (US)

Correspondence Address: DUGAN & DUGAN, PC, 55 SOUTH BROADWAY, TARRYTOWN, NY, 10591, US

(73) Assignee: Applied Materials, Inc.

(21) Appl. No.: 11/081,973

(22) Filed: Mar. 16, 2005

(51) Int. Cl. B08B 1/02; B08B 3/00

(52) U.S. Cl. 134/32; 134/34

(57) ABSTRACT

In a first aspect, a method is provided that includes the steps of (1) providing a tank having a volume of fluid filled to a level; (2) inserting a substrate into the tank; (3) displacing fluid in the tank due to a volume of the substrate; and (4) adjusting the volume of fluid in the tank to compensate for the volume of the substrate so as to maintain the level of fluid in the tank. Numerous other aspects are provided.

### FIELD OF THE INVENTION

The present invention relates generally to semiconductor device manufacturing, and more particularly to methods and apparatus for maintaining a fluid level in a tank during semiconductor device manufacturing.

### BACKGROUND

Conventionally, wafers are cleaned within tanks that may be filled with fluid. Fluid controls may be employed for maintaining a certain fluid concentration and temperature within the tank. However, other factors may cause variability during semiconductor device manufacturing. Accordingly, methods and apparatus for improving the consistency and reliability of semiconductor device manufacturing are desired.

### SUMMARY OF THE INVENTION

In a first aspect of the invention, a first method is provided. The first method includes the steps of (1) providing a tank having a volume of fluid filled to a level; (2) inserting a substrate into the tank; (3) displacing fluid in the tank due to a volume of the substrate; and (4) adjusting the volume of fluid in the tank to compensate for the volume of the substrate so as to maintain the level of fluid in the tank.

In a second aspect of the invention, a second method is provided for maintaining a fluid level in a tank. The second method includes the steps of (1) inserting at least one of a substrate and an end effector of a substrate handling robot into the tank; (2) displacing fluid in the tank due to a volume of the at least one of the substrate and the end effector; and (3) while displacing fluid in the tank due to a volume of the at least one of the substrate and the end effector, draining a volume of fluid from the tank equal to the volume of the at least one of the substrate and the end effector inserted into the tank.

In a third aspect of the invention, a third method is provided for maintaining a fluid level in a tank. The third method includes the steps of (1) inserting a first substrate and an end effector of a substrate handling robot into the tank; (2) displacing fluid in the tank due to a volume of the first substrate and the end effector; (3) while displacing fluid in the tank due to a volume of the first substrate and the end effector, draining a volume of fluid from the tank equal to the volume of the first substrate and the end effector inserted into the tank; (4) inserting a second substrate and the end effector into the tank; (5) displacing fluid in the tank due to a volume of the second substrate and the end effector; and (6) while displacing fluid in the tank due to a volume of the second substrate and the end effector, draining a volume of fluid from the tank equal to the volume of the second substrate and the end effector inserted into the tank.

In a fourth aspect of the invention, a fourth method is provided for maintaining a fluid level in a tank. The fourth method includes the steps of (1) inserting a first substrate and a first end effector of a substrate handling robot into the tank; (2) displacing fluid in the tank due to a volume of the first substrate and the first end effector; (3) inserting a second substrate and the first end effector into the tank; (4) displacing fluid in the tank due to a volume of the second substrate and the first end effector; (5) inserting a second end effector into the tank; (6) displacing fluid in the tank due to a volume of the second end effector; (7) removing the second end effector and the first substrate from the tank; and (8) based on a net change in a volume of the first substrate, the first end effector, the second substrate and the second end effector in the tank, at least one of draining a volume of fluid from the tank and flowing a volume of fluid into the tank. The steps of inserting at least one of the second substrate and the first end effector into the tank and removing the second end effector and the first substrate from the tank may overlap in time. Numerous other aspects are provided, as are methods, systems, apparatus and computer program products in accordance with these other aspects of the invention. Each computer program product described herein may be carried by a medium readable by a computer (e.g., a carrier wave signal, a floppy disc, a compact disc, a DVD, a hard drive, a random access memory, etc.).

Other features and aspects of the present invention will become more fully apparent from the following detailed description, the appended claims and the accompanying drawings.

### BRIEF DESCRIPTION OF THE FIGURES

FIG. 1 illustrates a first exemplary method for maintaining a fluid level in a tank during semiconductor device manufacturing in accordance with an embodiment of the present invention.

FIG. 2 is a block diagram of a first exemplary apparatus for maintaining a fluid level in a tank during semiconductor device manufacturing in accordance with an embodiment of the present invention.

FIG. 3 illustrates a second exemplary method for maintaining a fluid level in a tank during semiconductor device manufacturing in accordance with an embodiment of the present invention.

FIG. 4 is a block diagram of a second exemplary apparatus for maintaining a fluid level in a tank during semiconductor device manufacturing in accordance with an embodiment of the present invention.

### DETAILED DESCRIPTION

The present invention provides methods and apparatus for maintaining a fluid level in a tank during semiconductor device manufacturing. More specifically, the present invention provides methods and apparatus for adjusting a fluid volume in the tank when one or more substrates and/or end effectors (e.g., of a substrate handling robot) are inserted into and/or removed from the tank during semiconductor device manufacturing. In this manner, process variability may be reduced and semiconductor device manufacturing thereby may be improved. The present invention may also be used in tanks that employ continuous or timed periods of overflow, in which case, fluid volume is similarly adjusted so as to maintain consistent overflow.

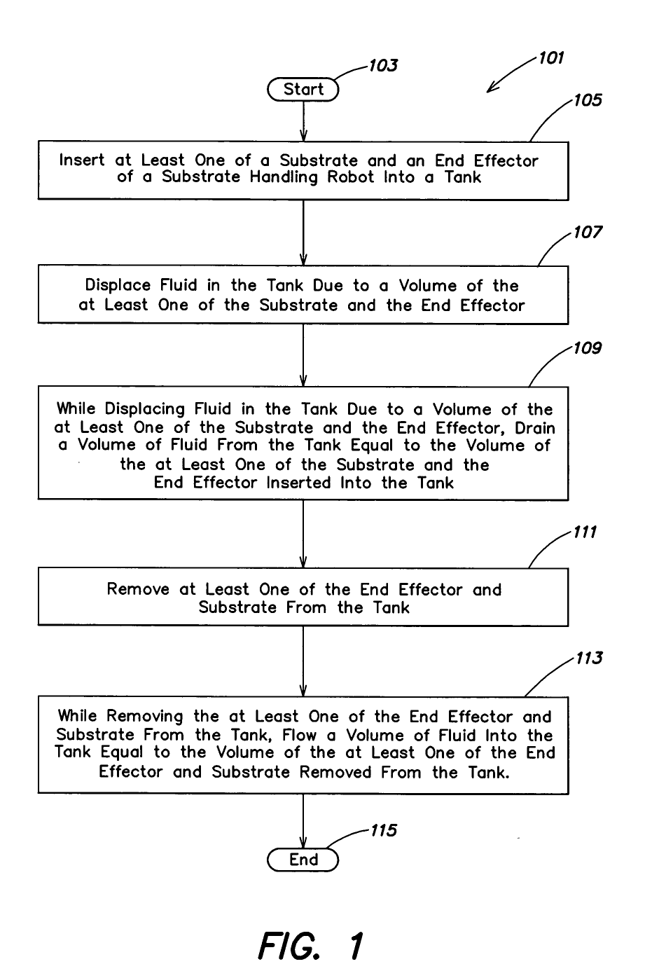

FIG. 1 illustrates a first exemplary method for maintaining a fluid level in a tank during semiconductor device manufacturing in accordance with an embodiment of the present invention. With reference to FIG. 1, in step 103 the method 101 of FIG. 1 begins. In step 105, at least one of a substrate and an end effector of a substrate handling robot are inserted into a fluid-filled tank. The tank, which is part of a semiconductor device manufacturing tool, is filled with a fluid, such as deionized water or a cleaning solution, for cleaning the substrate. The tank may be filled with the fluid to a predetermined level. The predetermined level may be a height slightly higher than the upper edges of the tank. Fluid in the tank may reach such a predetermined level due to surface tension of the fluid. For example, fluid may be maintained at such predetermined height by overflowing water from the upper edges of the tank at a constant flow rate, such as 1.5 L/m. However, other overflow rates may be employed.

In one embodiment, an end effector of a substrate handling robot supports and transports the substrate within the semiconductor device manufacturing tool. The end effector along with the substrate are inserted into the tank such that the substrate may be placed in the tank (e.g., onto a substrate support of the tank) for cleaning. Other methods may be employed for inserting the substrate into the tank. For example, in other embodiments, a substrate is inserted into the tank without inserting the end effector (e.g., is received by and lowered into the tank via a mechanism contained within the tank itself). Further, in other embodiments, an empty or unloaded end effector (e.g., an end effector that is not supporting a substrate) is inserted into the tank. For example, an unloaded end effector may be inserted into the tank for removing a substrate previously placed in the tank.

In step 107, fluid in the tank is displaced due to a volume of the at least one of the substrate and the end effector. As the substrate and/or the end effector (e.g. one or more portions of the substrate and/or the end effector) are inserted into the tank, an equal volume of fluid in the tank is displaced. Without further action, the fluid in the tank would exceed the predetermined level and/or may overflow from the tank at a greater than desired rate. Such a change in fluid level may affect drying (e.g., Marangoni drying) of a substrate previously inserted into the tank by creating a wave at the meniscus of the processed substrate, and therefore, a flow of drying vapor may not be injected at the meniscus which results in watermarks remaining on the substrate during and/or after the drying process.

However, in step 109, while displacing fluid in the tank due to the volume of the at least one of the substrate and the end effector, a volume of fluid equal to the volume of the at least one of the substrate and the end effector inserted into the tank is removed from the tank. For example, as one or more portions of the substrate and/or the end effector are inserted into the tank, a volume of fluid equal to the volume of such portions is removed from the tank. A drain valve coupled to the tank (e.g., via a tank drain line) may be actuated to remove the fluid from the tank. In this manner the fluid in the tank may remain at substantially the same level (e.g., the predetermined level), and consequently, the fluid may not overflow from the tank at a greater than desired rate. Therefore, the insertion of the substrate and/or the end effector does not perturb the fluid in the tank such that processing (e.g., drying) of another substrate (e.g., a substrate previously inserted) in the tank is adversely effected.

While in the tank, the substrate may be processed (e.g., cleaned). For example, the substrate may be processed using megasonic cleaning.

In step 111, at least one of the end effector and substrate may be removed from the tank. For example, after placing a substrate for processing on the substrate support, the end effector is removed from the tank. Alternatively, the end effector along with a processed substrate may be removed from the tank. Other methods may be employed for removing the substrate (e.g., after processing) from the tank. For example, in one or more embodiments, the processed substrate may be removed from the tank without employing the end effector (e.g., may be elevated from the tank via a mechanism contained within the tank itself). Consequently, the overall volume (e.g., the volume of any fluid, substrate and end effector) included in the tank is reduced. Without further action, by removing the end effector and/or the substrate from the tank, fluid in the tank would fall below the predetermined level as one or portions of the end effector and/or the substrate are removed from the tank, and/or water may not overflow from the tank at the desired rate. Such a change in fluid level may affect drying (e.g., Marangoni drying) of the substrate as the substrate is removed from the tank by creating a wave at the meniscus of the processed substrate, and therefore, a flow of drying vapor may not be injected at the meniscus which results in watermarks remaining on the substrate during and/or after the drying process.

However, in step 113, while removing the at least one of the end effector and substrate from the tank, a volume of fluid equal to the volume of the at least one of the end effector and substrate removed from the tank is flowed into the tank. For example, as one or more portions of the substrate and/or the end effector are removed from the tank, a volume of fluid equal to the volume of such portions is supplied to tank. A fluid supply valve coupled to the tank may be actuated to flow fluid into the tank. In this manner, the fluid in the tank may remain at substantially the same level (e.g., the predetermined level). Additionally, a consistent fluid overflow rate may be maintained in the tank during semiconductor device manufacturing. When the substrate is removed from the tank 203, Marangoni drying may be employed for drying the substrate. By maintaining the fluid at the predetermined level, the present method maintains a constant distance between the fluid level and a source of drying (e.g., isopropyl alcohol (IPA)) vapors, and consequently, accurately and reliably delivers drying vapors to a meniscus without requiring any adjustment of a drying vapor delivery angle. Therefore, the removal of the substrate and/or the end effector does not perturb the fluid in the tank such that processing (e.g., drying) of the substrate and/or processing (e.g., cleaning) of another substrate (e.g., a substrate subsequently inserted either while the first substrate is in the tank, or after removal thereof) in the tank is adversely effected. In some embodiments the constant distance may be less than about 0.75 inches (although a larger or smaller distance may be employed). Thereafter, step 115 is performed. In step 115, the method 101 ends.

In one or more embodiments, insertion and removal of an end effector and/or a substrate may overlap in time. In such embodiments, a net change of volume inserted into and/or removed from the tank (e.g., the volume of any substrate or end effector inserted into the tank or the volume of any substrate or end effector removed from the tank) may be determined and a volume of fluid flowed into or drained from the tank may be based on such determination.

Through use of the method 101 for maintaining a fluid level in a tank during semiconductor device manufacturing, the fluid volume in the tank is adjusted when one or more substrates and/or end effectors (e.g., of a substrate handling robot) are inserted into and/or removed from the tank during semiconductor device manufacturing. Consequently, watermarks left on a substrate after processing may be reduced and/or semiconductor device manufacturing yield may be improved.

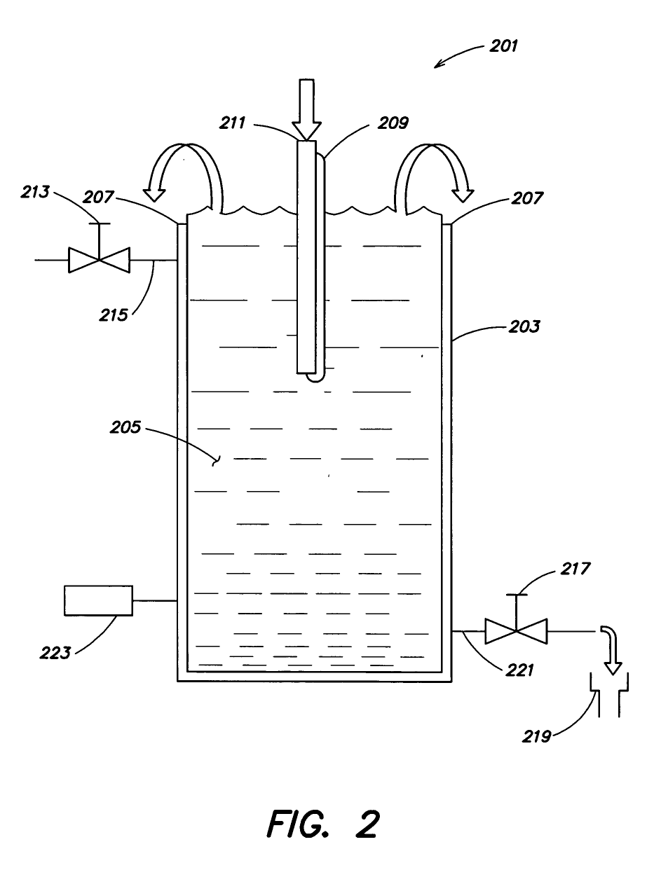

An apparatus for maintaining a fluid level in a tank during semiconductor device manufacturing is now described with reference to FIG. 1 and with reference to FIG. 2 which is a block diagram of a first exemplary apparatus for maintaining a fluid level in a tank during semiconductor device manufacturing in accordance with an embodiment of the present invention. With reference to FIG. 2, the apparatus 201 for maintaining a fluid level in a tank during semiconductor device manufacturing includes a tank 203 for processing substrates, such as a megasonic cleaning tank. The tank 203 may be filled with fluid 205, such as deionized water or a cleaning solution, etc. As described above, the tank 203 may be filled to a height slightly higher than the upper edges 207 of the tank 203. A substrate 209 (e.g., a glass substrate, a semiconductor wafer, etc.) may be inserted into the tank 203 for processing. An end effector or blade 211 of a substrate handling robot (not shown) for supporting and transporting the substrate 209 may be employed to insert the substrate 209 into the tank 203 for processing. Therefore, the end effector and/or the substrate 209 may be inserted into the tank 203.

A fluid supply valve 213, which is coupled to and receives input from a fluid supply (not shown), is coupled to the tank 203 via a tank fluid input line 215. The fluid supply valve 213 controls a flow of fluid from the fluid supply (not shown) to the tank 203. A fluid drain valve 217, whose output is operatively coupled to a fluid drain 219, is coupled to the tank 203 via a tank fluid output 221. The fluid drain valve 217 controls a flow of fluid from the tank 203 to the drain 219. In one embodiment, the drain 219 may be included in a containment tank (not shown) placed below the tank 203. Other drains may be employed.

A controller 223, which may include one or more microprocessors, microcontrollers and/or computer program products, is coupled to the tank 203. The controller 223 is adapted to perform the steps of the method 101 of FIG. 1 such that a desired fluid level is maintained in the tank 203 during semiconductor device manufacturing. More specifically, as described above, when an end effector and/or a substrate 209 is inserted into or removed from the tank 203, fluid may be drained from and/or supplied to the tank 203 such that fluid in the tank 203 is maintained at a desired height (e.g., the predetermined level). Maintaining the fluid in the tank 203 at such predetermined level may include overflowing fluid from the tank 203 at a constant rate.

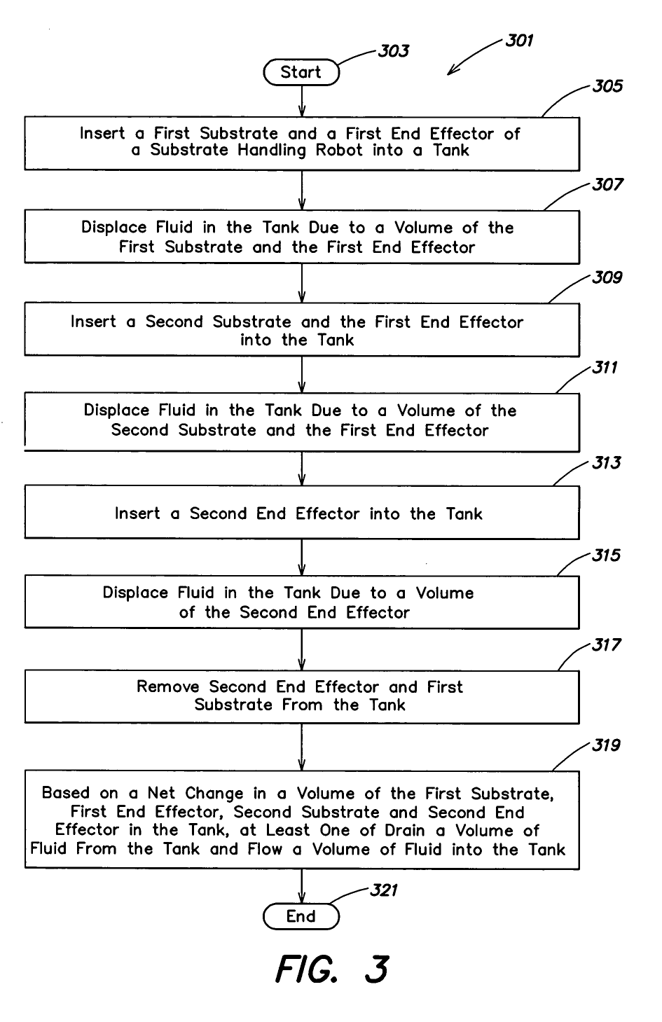

FIG. 3 illustrates a second exemplary method for maintaining a fluid level in a tank during semiconductor device manufacturing in accordance with an embodiment of the present invention. With reference to FIG. 3, in step 303, the method 301 begins. In step 305, a first substrate and a first end effector of a substrate handling robot are inserted into a fluid-filled tank. The tank may include at lease a partial wall for dividing the tank into a first side and a second side. Similar to the tank employed in the first exemplary method 101 for maintaining a fluid level in a tank during semiconductor device manufacturing, the tank employed in the present method may be filled with the fluid to a predetermined level. As stated, the predetermined level may be a height slightly higher than the upper edges of the tank. Fluid in the tank may reach such a predetermined level due to surface tension of the fluid. For example, fluid may be maintained at such predetermined height by overflowing water from the upper edges of the tank at a constant flow rates, such as 1.5 L/m. However, other overflow rates may be employed. The first substrate and the first end effector may be inserted into a first side of the tank so that the first substrate may be processed. More specifically, the first end effector may place the substrate onto a substrate support of the tank.

In step 307, fluid in the tank is displaced due to a volume of the first substrate and the first end effector. As the first substrate and the first end effector (e.g. one or more portions of the first substrate and the first end effector) are inserted into the first side of the tank, an equal volume of fluid in the tank is displaced. Thereafter, the first end effector may be removed from the tank. While in the first side of the tank, the first substrate may be cleaned (e.g., megasonically). After cleaning, the first substrate may be transferred to the second side of the tank for removal and drying.

In step 309, a second substrate and the first end effector are inserted into the tank. For example, the first end effector and the second substrate are inserted into the first side of the tank so that the second substrate may be processed. Similar to the first substrate, the first end effector may place the second substrate onto the substrate support for cleaning.

In step 311, fluid in the tank is displaced due to a volume of the second substrate and the first end effector. As the second substrate and the first end effector (e.g. one or more portions of the second substrate and the first end effector) are inserted into the first side of the tank, an equal volume of fluid in the tank is displaced. Thereafter, the first end effector may be removed from the tank.

In step 313, a second end effector is inserted into the tank. For example, the second end effector may be inserted into the second side of the tank for removing a cleaned substrate (e.g., the first substrate) from the tank.

In step 315, fluid in the tank is displaced due to a volume of the second end effector. As the second end effector (e.g. one or more portions of the second end effector) are inserted into the second side of the tank, an equal volume of fluid in the tank is displaced.

In step 317, the second end effector and the first substrate are removed from the tank. More specifically, the second end effector is removed from the tank while supporting the first substrate, which was cleaned and/or rinsed in the tank. As the first substrate (along with the second end effector) is removed from the tank, the first substrate is Marangoni dried. The removal of the second end effector and first substrate from the tank may overlap in time with the insertion of the first end effector and the second substrate into the tank. In this manner, more than one substrate may be processed in the tank at any given time, thereby increasing manufacturing throughput. For example, the first substrate may be Marangoni dried while the second substrate is megasonically cleaned.

In step 319, based on a net change in a volume of the first substrate, first end effector, second substrate and second end effector in the tank, a volume of fluid is drained from the tank and/or a volume of fluid is flowed into the tank. For example, when a net increase in a volume of the first substrate, first end effector, second substrate and second end effector included in (e.g., inserted into) the tank occurs, a corresponding volume of fluid is displaced. Consequently, to compensate for such displaced fluid, a corresponding volume of fluid may be removed from the tank. For example, if insertion of the first end effector and second substrate (e.g., portions of the first end effector and portions of the second substrate) into the tank cause a net increase in a volume of the first substrate, first end effector, second substrate and second end effector included in the tank, a corresponding volume of fluid may be drained from the tank. As a further example, if insertion of the first end effector and second substrate (e.g., portions of the first end effector and portions of the second substrate) during removal of the first substrate (e.g., portions of the first substrate) from the tank causes a net increase in a volume of the first substrate, first end effector, second substrate and second end effector included in the tank, a corresponding volume of fluid may be drained from the tank.

A drain valve coupled to the tank (e.g., via a tank drain line) may be actuated to remove the fluid from the tank. In this manner the fluid in the tank may remain at substantially the same level (e.g., the predetermined level), and/or, the fluid may not overflow from the tank at a greater than desired rate. Therefore, the insertion of the substrate and/or the end effector which causes the net increase in the volume of the first substrate, first end effector, second substrate and second end effector in the tank does not perturb the fluid in the tank such that processing (e.g., drying) of another substrate (e.g., a substrate previously inserted) in the tank is adversely effected.

Similarly, when a net decrease in a volume of the first substrate, first end effector, second substrate and second end effector included in (e.g., inserted into) the tank occurs, to compensate for such decrease in volume, a corresponding volume of fluid may be supplied to the tank. For example, if removal of the first substrate (e.g., portions of the first substrate) from the tank causes a net decrease in volume of the first substrate, first end effector, second substrate and second end effector included in the tank, a corresponding volume of fluid may be flowed to the tank. As a further example, if insertion of the second substrate (e.g., portions of the second substrate) during removal of the first substrate (e.g., portions of the first substrate) from the tank causes a net decrease in a volume of the first substrate, first end effector, second substrate and second end effector included in the tank, a corresponding volume fluid may be flowed into the tank to compensate for such decrease. A fluid supply valve coupled to the tank may be actuated to flow fluid into the tank. In this manner, the fluid in the tank may remain at substantially the same level (e.g., the predetermined level). Additionally, a consistent fluid overflow rate may be maintained from the tank during semiconductor device manufacturing. Thereafter, step 321 is performed. In step 321, the method 301 ends.

The above-described insertion into and/or removal from the tank of end effector and/or substrate volumes are exemplary. It should be understood that the present methods may be employed to compensate for an individual or concurrent insertion and/or removal of one or more portions of any end effector or substrate.

Although in the embodiment above, the first end effector is employed (e.g., inserted into the tank) to insert substrates into the tank and the second end effector is employed (e.g., inserted into the tank) to remove substrates from the tank, in other embodiments, the first end effector may not be employed to insert a substrate into the tank and/or the second end effector may not be employed to remove a substrate from the tank. In such embodiments, the method 301 of FIG. 3 may be modified accordingly. For example, there may be a mechanism within the tank for lowering and/or raising a substrate to/from the tank.

Similar to the method 101 of FIG. 1, through use of the method 301 for maintaining a fluid level in a tank during semiconductor device manufacturing, the fluid volume in the tank is adjusted when one or more substrates and/or end effectors (e.g., of a substrate handling robot) are inserted into and/or removed from the tank during semiconductor device manufacturing. Consequently, processing variability may be reduced and semiconductor device manufacturing throughput and yield may be improved.

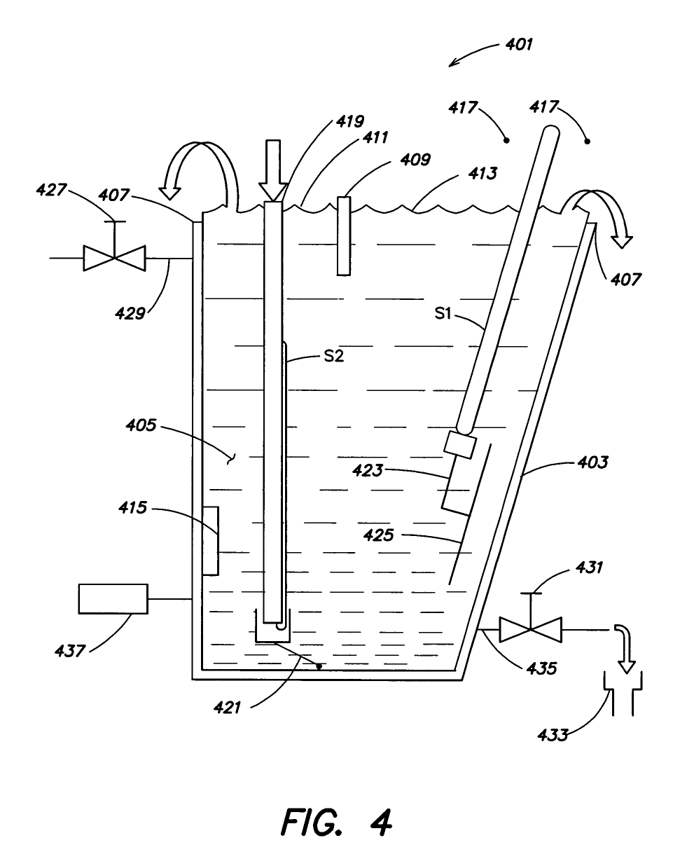

An apparatus for maintaining a fluid level in a tank during semiconductor device manufacturing is now described with reference to FIG. 3 and with reference to FIG. 4 which is a block diagram of a second exemplary apparatus for maintaining a fluid level in a tank during semiconductor device manufacturing in accordance with an embodiment of the present invention. With reference to FIG. 4, the apparatus 401 for maintaining a fluid level in a tank during semiconductor device manufacturing includes a tank 403 for processing substrates, such as a megasonic cleaning tank. The tank 403 may be filled with fluid 405, such as deionized water or a cleaning chemistry, etc. As described above, the tank 403 may be filled with fluid to a height slightly higher than the upper edges 407 of the tank 403. The tank 403 may include a wall 409 for dividing the tank 403 into a first side 411 and a second side 413. The first side 411 of the tank may be employed for cleaning (e.g., megasonically) a substrate. For example, the first side 411 of the tank 403 may include one or more transducers 415 (only one shown) for megasonic cleaning.

The apparatus 401 may include one or more drying vapor nozzles 417 above the second side 413 of the tank 403. Therefore, the second side 413 of the tank 403 may be employed for vapor drying (e.g., Marangoni drying).

A substrate (e.g., a first substrate S1) may be inserted into the tank 403 (e.g., the first side 411 of the tank) for processing. A first arm 419 (e.g., an end effector or blade) of a substrate handling robot (not shown) for supporting and transporting the substrate S1 may be employed to insert the substrate S1 into the tank 403 for processing. The tank 403 includes a mechanism 421 for transferring a substrate from the first side 411 of the tank 403 to the second side 413 of the tank 403. For example, the mechanism 421 may transfer a substrate from the first side 411 of the tank to the second side 413 of the tank 403 after cleaning.

The second side 413 of the tank 403 may include a pusher means 423 and guide rails 425. The guide rails 425 guide a wafer as the pusher means 423 removes (e.g., raises) the substrate from the tank 403.

The tank 403 may process more than one wafer at a time. For example, the tank 403 may include a first wafer S1 (e.g., which may be undergoing drying) in the second side 413 of the tank 403 (e.g. upon extraction therefrom) and a second wafer S2 (e.g., which may be undergoing megasonic cleaning) in the first side 411 of the tank 403.

Similar to the tank 203 of the first exemplary apparatus 201, the second exemplary apparatus 401 includes a fluid supply valve 427, which is coupled to and receives input from a fluid supply (not shown), coupled to the tank 403 via a tank fluid input 429. The fluid supply valve 427 controls a flow of fluid from the fluid supply (not shown) to the tank 403. A fluid drain valve 431, whose output is operatively coupled to a fluid drain 433, is coupled to the tank 403 via a tank fluid output 435. The fluid drain valve 431 controls a flow of fluid from the tank 403 to the drain 433. In one embodiment, the drain 433 may be included in a containment tank (not shown) placed below the tank 403. Other drains may be employed.

A controller 437, which may include one or more microprocessors, microcontrollers and/or computer program products, is coupled to the tank 403. The controller 437 is adapted to perform the steps of the method 301 of FIG. 3 such that a desired fluid level is maintained in the tank 403 during semiconductor device manufacturing. More specifically, as described above, when an end effector and/or a substrate S1, S2 is inserted into and/or removed from the tank 403, fluid may be drained from and/or supplied to the tank 403 such that fluid in the tank is maintained at a desired height (e.g., the predetermined level). Maintaining the fluid in the tank 403 at such predetermined level may include overflowing fluid from the tank 403 at a constant rate.

The foregoing description discloses only exemplary embodiments of the invention. Modifications of the above disclosed apparatus and methods which fall within the scope of the invention will be readily apparent to those of ordinary skill in the art. For instance, although one or more embodiments of the present methods and apparatus are described above, according to a broad aspect of the present methods and apparatus, a tank having a volume of fluid filled to a level is provided. A substrate is inserted into the tank such that fluid in the tank is displaced due to a volume of the substrate. The volume of fluid in the tank is adjusted to compensate for the volume of the substrate so as to maintain the level of fluid in the tank. By maintaining the level of fluid in the tank, the present method may in one aspect, maintain a predefined distance between the fluid level and a source of drying vapor (e.g., IPA vapor). In any aspect, more than one substrate may be inserted or extracted from the tank simultaneously (e.g., substrates may be transferred in batches of plural substrates).

Accordingly, while the present invention has been disclosed in connection with exemplary embodiments thereof, it should be understood that other embodiments may fall within the spirit and scope of the invention, as defined by the following claims.

The invention claimed is:

1. A method of maintaining a fluid level in a tank, comprising:
inserting at least one of a substrate and an end effector of a substrate handling robot into the tank;
displacing fluid in the tank due to a volume of the at least one of the substrate and the end effector; and
while displacing fluid in the tank due to a volume of the at least one of the substrate and the end effector, draining a volume of fluid from the tank equal to the volume of the at least one of the substrate and the end effector inserted into the tank.

2. The method of claim 1 wherein draining a volume of fluid from the tank includes actuating a fluid drain valve.

3. The method of claim 1 further comprising:
removing at least one of the end effector and substrate from the tank; and
while removing the at least one of the end effector and substrate from the tank, flowing a volume of fluid into the tank equal to the volume of the at least one of the end effector and substrate removed from the tank.

4. The method of claim 3 wherein flowing a volume of fluid into the tank includes actuating a fluid supply valve.

5. The method of claim 3 wherein removing at least one of the end effector and substrate from the tank comprises removing only the end effector from the tank such that the substrate remains in the tank; and
thereafter, further comprising:
inserting the end effector into the tank;
displacing fluid in the tank due to a volume of the end effector; and
while displacing fluid in the tank due to a volume of the end effector, draining a volume of fluid from the tank equal to the volume of the end effector inserted into the tank.

6. The method of claim 5 further comprising:
removing the end effector and the substrate from the tank; and
while removing the end effector and the substrate from the tank, flowing a volume of fluid into the tank equal to the volume of end effector and the substrate removed from the tank.

7. The method of claim 1 further comprising:
removing the substrate from the tank; and
while removing the substrate from the tank, Marangoni drying the substrate.

8. The method of claim 7 further comprising megasonically cleaning the substrate.

9. A method of maintaining a fluid level in a tank, comprising:
inserting a first substrate and an end effector of a substrate handling robot into the tank;
displacing fluid in the tank due to a volume of the first substrate and the end effector;
while displacing fluid in the tank due to a volume of the first substrate and the end effector, draining a volume of fluid from the tank equal to the volume of the first substrate and the end effector inserted into the tank;
inserting a second substrate and the end effector into the tank;
displacing fluid in the tank due to a volume of the second substrate and the end effector; and
while displacing fluid in the tank due to a volume of the second substrate and the end effector, draining a volume of fluid from the tank equal to the volume of the second substrate and the end effector inserted into the tank.

10. The method of claim 9 further comprising:
removing the end effector from the tank; and
while removing the end effector from the tank, flowing a volume of fluid into the tank equal to the volume of the end effector removed from the tank.

11. The method of claim 9 further comprising:
removing the first substrate from the tank; and
while removing the first substrate from the tank, flowing a volume of fluid into the tank equal to the volume of the first substrate removed from the tank.

12. The method of claim 11 wherein flowing a volume of fluid into the tank includes actuating a fluid supply valve.

13. The method of claim 11 wherein inserting at least one of the second substrate and the end effector into the tank and removing the first substrate from the tank overlap in time.

14. The method of claim 9 further comprising:
inserting a second end effector into the tank; and
displacing fluid in the tank due to a volume of the second end effector; and
while displacing fluid in the tank due to a volume of the second end effector, draining a volume of fluid from the tank equal to the volume of the second end effector inserted into the tank.

15. The method of claim 14 further comprising:
removing the second end effector and the first substrate from the tank; and
while removing the second end effector and the first substrate from the tank, flowing a volume of fluid into the tank equal to the volume of second end effector and the first substrate removed from the tank.

16. The method of claim 9 further comprising:
removing the first substrate from the tank; and
while removing the first substrate from the tank, Marangoni drying the first substrate.

17. The method of claim 16 further comprising megasonically cleaning the first substrate.

18. A method of maintaining a fluid level in a tank, comprising:
inserting a first substrate and a first end effector of a substrate handling robot into the tank;
displacing fluid in the tank due to a volume of the first substrate and the first end effector;
inserting a second substrate and the first end effector into the tank;
displacing fluid in the tank due to a volume of the second substrate and the first end effector;
inserting a second end effector into the tank;
displacing fluid in the tank due to a volume of the second end effector;
removing the second end effector and the first substrate from the tank; and
based on a net change in a volume of the first substrate, first end effector, second substrate and second end effector in the tank, at least one of draining a volume of fluid from the tank and flowing a volume of fluid into the tank;
wherein inserting at least one of the second substrate and the first end effector into the tank and removing the second end effector and the first substrate from the tank overlap in time.

19. The method of claim 18 further comprising, while removing the first substrate from the tank, Marangoni drying the first substrate.

20. The method of claim 19 further comprising megasonically cleaning the first substrate.
